(19) United States
(12) Patent Application Publication
(10) Pub. No.: US 2006/0078126 A1
(43) Pub. Date: Apr. 13, 2006

(54) Floating vector scrambling methods and apparatus

(76) Inventor: Philip Cacayorin, White Salmon, WA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/245,745

(22) Filed: Oct. 7, 2005

Related U.S. Application Data
(60) Provisional application No. 60/617,345, filed on Oct. 8, 2004.

(51) Int. Cl. H04L 9/00; H04K 1/00

(52) U.S. Cl. 380/275; 380/44

(57) ABSTRACT

A cryptographic system splits a digital message into multiple parts, and scrambles sequencing of the multiple parts according to an algorithm requiring first and second keys to resolve. The keys can be related by a graphically recognizable mathematical formula, and can be implemented by a third party or other secure key management infrastructure, and can support pay-per-play subscription models. Scrambled messages can be stored on a CD, DVD or other memory, with the multiple parts being distributed on different storage hosts. Contemplated messages include digitized video or other movies, books, music, or any other type of information. Messages can be split according to color separations, video and audio tracts, frequency ranges, or in any other manner. Splitting of the message into the multiple parts can be used as a fingerprint in identifying a creator of the message.

This application claims priority to U.S. Provisional Application Ser. No. 60/617,345 filed Oct. 8, 2004.

### FIELD OF THE INVENTION

The field of the invention is cryptography.

### BACKGROUND

There is an on-going need to protect security of data. The problem has been recognized for decades, but has become especially relevant to large numbers of people with the popularization of the Internet. There are numerous technologies in use, and still others that have been suggested, but never implemented. Among the known technologies are those described in the following listed patent publications. These and all other referenced patents and applications are incorporated herein by reference in their entirety.
U.S. Pat. Nos. 5,093,827, 5,130,984, 5,166,926, 5,187,707, 5,197,064, 5,448,558, 5,508,16, 5,566,170, 5,598,410, 5,822,300, 6,014,380, 6,032,190, 6,034,957, 6,081,522, 6,085,238, 6,088,356, 6,091,725, 6,112,251, 6,192,483, 6,262,976, 6,295,299, 6,321,272, 6,327,253, 5,632,011, 6,072,942, 4,177,510, 4,621,321, 4,870,571, 5,272,754, 5,333,266, 4,805,207, 5,414,833, 5,530,758, 4,672,572, 4,259,720, 5,105,424, 5,278,955, 5,432,850, 5,353,283, 5,606,668, 5,623,601, 5,023,907, 5,448,561, 5,481,721, 5,754,774, 5,699,513, 5,706,507, 5,720,035, 5,781,550, 5,918,018, 6,061,798, 5,826,014, 4,727,243, 6,041,355, 0010006522, 0010016878, 0010021176, 0010034795, 0010042221, 0010044758, 0010044837, 0010044879, 0010047353, 0010049677, 0010049741, 0010052016, 0010056416 and 20030233328.

The most popular technology is the public key system, and several standards based on it have been developed. Public key based encryption standards are all “strong” encryptions, and are proven to be very difficult, or perhaps even impossible to attack when a long enough key is used. But the public key system has an intrinsic weak point. Since the user is normally linked to the private/public key for a long period, attackers have a lot of time to break the private key. And if the private key is stolen or lost, the unsuspecting user could unwittingly continue to employ it for a long period since it is impossible to know if the key has been compromised.

Another related problem is trust. Since the producer has all the information of the user's private key, an end user has to believe that the producer won't misuse or disclose this information to a third party.

Human beings are the ones that develop and use encryption tools, and human beings make errors. Usually it is the human factor that creates the security problem. For example, a private key can simply be lost and quite often people are not careful enough to prevent the private key from being stolen. A good cryptosystem should take care of such cases, and limit the possible damage.

Thus, what is needed is a security technology that is not reliant on users remembering a particular key. One possible solution is to use continuously varying keys. That strategy is analogous to the use of continuously varying frequencies in anti-jamming radars.

Indeed, continuously varying keys is merely an encryption algorithm as opposed to a scrambling algorithm. What is needed is a true scrambling algorithm.

### SUMMARY OF THE INVENTION

The present invention provides systems and methods in which portions of a message are encoded using multiple encoding algorithms. This strategy, referred from time to time as floating vectors, differs significantly from the prior art, which encodes the entire message with a single key, or different portions of the message with different keys of the same encryption algorithm. The term “message” is used here in its broadest possible sense, to mean any data whatsoever, whether in an email, file, or any other form, whether packetized or not, whether or not resident on a storage device, whether or not the message is being communicated, and so forth.

The multiple algorithms can be applied to the different portions on a time division multiplex-style broadcast, according to file segments, or in any other manner.

Any encryption algorithm can be scrambled since the process is relative to any binary language. A preferred protocol uses the Pythagorean Theorem to calculate an infinite number of symmetries based on two designated sums. The calculation provides the broadcaster with the ability to perform real-time analysis of the recipient and unscrambling requirements.

### BRIEF DESCRIPTION OF THE DRAWING

FIG. 1 is a diagram showing how the Pythagorean theorem can be used to correlate a subscriber ID and a subscriber set.

FIG. 2 is a diagram showing how the Pythagorean theorem can be used to provide a de-scrambling kernel with a key.

FIG. 3 is a diagram showing how the Pythagorean theorem can be used to provide a de-scrambling kernel with a floating vector value.

FIG. 3A is a chart exemplifying a first exemplary calculation of a Personalized Virtual Private Network Identification (PVPNID).

FIG. 3B is a chart exemplifying a second exemplary calculation of a Personalized Virtual Private Network Identification (PVPNID).

FIG. 4 is a schematic of use of MIME in protecting a movie via Securely Personalized Distributed Object Fragmentation (SPDOF).

Various objects, features, aspects and advantages of the present invention will become more apparent from the following detailed description of preferred embodiments of the invention, along with the accompanying drawing figures.

### DETAILED DESCRIPTION

A. Benefits and Implementation

The inventive technology, referred to herein as ST1, can be described as a digital version of analog television broadcast scrambling. One significant advantage is that it can bridge all forms of digital appliances. Therefore, data secured through ST1 can be received on any display platform or terminal be it, television, computing devices, cellular phones, wireless PDA devices, and the like. ST1 is also advantageous in that that it can bridge any transmission medium—from satellites to fiber optic. So it is not merely an Internet-based technology and is not restricted only to PCs. As a result, ST1 is a very versatile hybrid communication software combining the best of new and mainstream concepts of both scrambling and encryption methodologies. Finally, ST1 can provide for data to become “digitally fingerprinted” and inexorably linked to the creator of that data.

ST1 is preferably implemented using a subscription based platform, in which each end-user has the ability to create proprietary data and communication channels based on the customized platform each corporation or individual creates. This results in a platform that can be made unique to every licensed user in the world, be it an individual, an organization, or departments within organizations.

The ability to provide enterprises and end-users a way to uniquely personalize digital data and all point-to-point communications in real-time is significant for it now makes information and communication security not only personalized but also convenient, especially since it directly facilities better security for the burgeoning field of Peer-to-Peer (“P2P”) Networking and Communication.

ST1 preferably functions in real-time, not only scrambling the data during a session, but also scrambling each point-to-point transmission of data that takes place between the participants during the session. This prevents communications between parties not already authorized to do so. Internet users can now communicate on their own private digital channel with confidentiality, privacy, authentication and data integrity.

B. Distinctions Over Time Varied Encryption Algorithms

ST1 is a scrambling algorithm. It's not an encryption algorithm. (An algorithm is simply a process for completing a task.). Encryption uses a cipher algorithm. A cipher algorithm's task is to disguise a message by turning plain text into ciphertext—all the text data are jumbled up together and locked in a box—unreadable to all except the one with the key to open the box.

A scrambling algorithm is different. Its task is to split all the data apart and bring them back together again in one piece somewhere else. Encryption is often described as “data scrambling” but should not be confused with the kind of traditional analog scrambling systems that ST1 emulates. Scrambling systems are traditionally applied to analog television signals to ensure a signal is only receivable by the audience for which it is intended (i.e., to “those who have paid to receive it.”) Therefore a good scrambling system is one that can effectively make the picture unusable to all except those who have paid.

Scrambling algorithms and cipher algorithms perform differently, yet both are used to secure data within their specific environments. Encryption is now firmly rooted in the digital environment and there are numerous cipher algorithms currently available to secure a document, email, or a bank transaction in the digital realm.

The scrambling systems seen to date however are all firmly rooted in analog technology. It would be better to describe these systems as transitional systems rather than digital systems. VideoCrypt™, D2-MAC EuroCrypt™ (M, S, S*, S2) and Nagra/Syster™ are all transitional systems. They all have to digitize the video signal in order to decode it.

ST1 emulates methods used to scramble analog TV signals—but with one major difference: ST1 is designed purely as a digital technology for digital data. ST1 technology therefore completes the transition from analog scrambling to digital scrambling. But unlike traditional TV analog scrambling which targets only video, ST1 can be applied to video and any other kind of digital data or communications.

ST1 can apply ciphers, scramble, personalize, and authenticate static data and dynamic communications. On the other hand, encryption just encrypts. For encryption technology to provide an end-to-end system and function in a somewhat similar manner as ST1, it needs to be integrated with a Virtual Private Network (VPN) or Public Key Infrastructure (PKI), which involves the participation of Certificate Authorities and the use of digital certificates. These solutions are extremely complicated and costly compared to ST1 and its real-time scrambling capabilities.

Given the limits of today's Internet bandwidth restrictions, the inherent scrambling functionality of ST1 can help solve resolution problems for the secure delivery of entertainment media over the Internet, whereas encryption cannot.

In the final analysis, ST1 is a hybrid technology within which encryption plays just one part. The addition of personalized scrambling not only provides an additional level of security over encryption, it also opens the door for communications that are completely “subscription-based.”

The distinction between encryption and scrambling technologies is a vital technical and marketing differentiator. ST1 allows every individual and organization in the world to have a distinct digital identity. By incorporating the ST1 digital scrambling kernel as a fingerprinting process, all point-to-point communications can perform on a “subscription-based” platform whereby a Virtual Private Network can be personalized. Each person or organization becomes his/her/its own VPN.

C. Preferred Floating Vector Protocols

The Floating Vector Protocol enables The Personalized Virtual Private Network to be a viable solution to the revitalization of public communications networks. The secure personalization protocol provides a viable mathematical solution to secure personalization and real-time identity confirmation over a public IP Network. The communications protocol provides the user with the ability to scramble any digital data by changing encryption platforms in real-time during the broadcasting process. Only the intended recipient of this data will have the ability to mutually change platforms, decrypt and unscramble the data.

In preferred embodiments, the protocol represents a mathematical representation of 2 two-dimensional shapes that are bound together symmetrically to create a single three-dimensional shape. Once these measurements are established between the two-dimensional shapes mathematically, the polygons create an infinite template of values from a point in space. This process is achievable by creating unique identifiers as values and utilizing the Theorem against those values.

A particularly preferred embodiment uses the Pythagorean Theorem because it provides an infinite number of symmetries based on two designated sums. This calculation provides the broadcaster with the ability to perform real-time analysis of the recipient and unscrambling requirements. While randomly embedding the data stream with numbers that instruct specific tests and processes during the broadcast phase, these numbers are modeled to a specific symmetry that is only understood by the intended recipient.

In this preferred embodiment, the recipient has a preset kernel template modeled to unscramble specific leading codes into instruction sets. These instruction sets dictate the unscrambling and identifying tasks:

1) In collaboration with an online service portal, a portable medium provides an install for a new kernel template. The New Kernel Template (NKT) provides the necessary architecture to establish a Virtual Private Network on a VoIP or TCP/IP style connection.

2) The installation of a NKT is performed on the intended IP device targeted to establish a subscription.

3) On completion of the NKT install, the installer provides the subscriber with the ability to communicate with the service portal to establish and perform a new subscription or to enroll in an existing affiliate PVPNID.

4) In the new subscription process, the kernel uploads the apparatus' IP information and downloads the assigned protocol “sets” into the NKT of the specific IP apparatus. The sets contain preset instructions modeled for a specific Personalized Virtual Private Network Identification (PVPNID).

5) The original subscriber adopts affiliates to the specific PVPNID by petitioning the recipients designated by the original subscriber. The recipients are contacted by way of their IP apparatus to subscribe to the service portal and performing the same subscription process.

6) The unique sets provide the subscriber with the ability bring other users or apparatus into the specific PVPNID. It will also create alternative versions with unique PVPNID's to expand the PVPN to an infinite number of subscribers and levels of PVPN'S.

7) Systematically from the broadcast source, collaborative identifiers embedded into the media secure deliveries to the targeted recipients by scrambling the media with several kinds of encryption platforms.

8) To unscramble the media successfully, the collaborative values of the PVPNID provide what, where and when specific encryptions are used. Only the subscribed kernels will contain the critical information required to unscramble and decrypt the media successfully. In such embodiments the collaborative values could be considered public keys, and the critical information provided by the kernels could be considered private keys.

9) The sender or broadcaster has the ability to randomly change an identifier in real-time or manually. The nature of the Theorem provides that a quantified algorithmic structure of security remains intact, insuring the identity of the recipients. Therefore, any deviation of symmetry would provide an invalidation of identity without the ability to assign specific decryption protocols to the media.

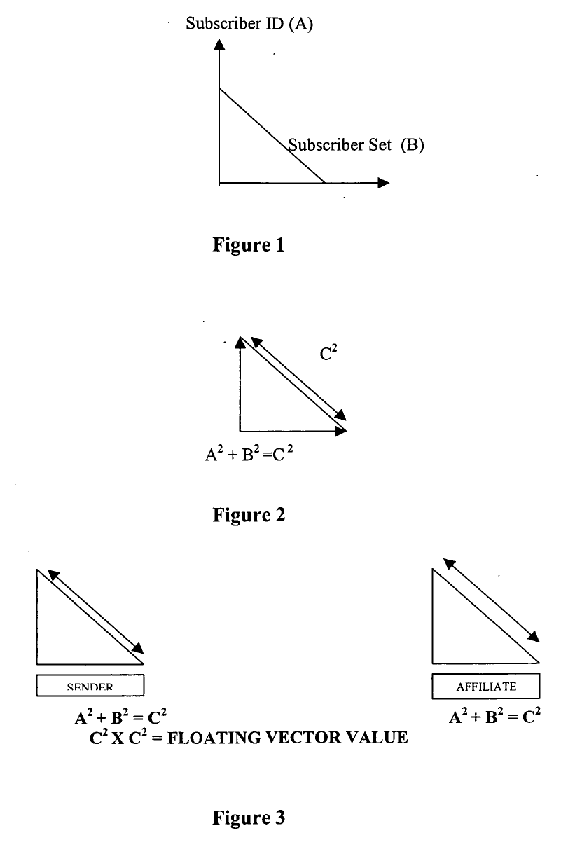

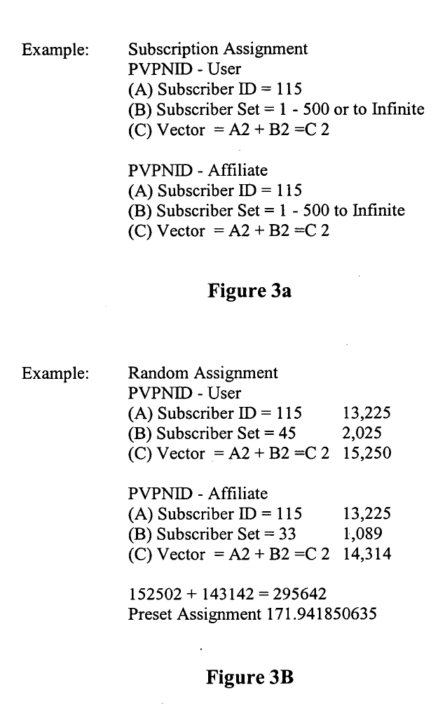

On a basic level of implementation, the PVPNID identifiers can be assigned to A and B values (see FIG. 1). These values are assigned to the base and axis of a 2-Dimentional right angle triangle. By utilizing The Pythagorean Theorem we determine a distance between the two points (C), based on the A & B values (see FIG. 2). The Pythagorean Theorem is applied to the sum of each subscribers' two identifiers within the PVPNID to provide the kernel with a value to complete a 3 Dimensional object between the two 2 Dimensional objects created by the unique identifiers (see FIG. 1).

Of course, any other suitable mathematical relationship could also be implemented. For example, obtuse or acute triangles could be used in place of a right triangle, and one could alternatively use elliptical or other graphically recognizable formulas. The formulas need not even be graphically recognizable.

D. Subscription Based Embodiment

In preferred embodiments, ST1 scrambled data will only unscramble to a distinct identity. Consequently, communications within an ST1-based environment cannot occur between two parties unless one user is subscribed to another user's platform.

Accordingly, ST1-scrambled content cannot be accessed unless an ST1 communications platform is set up between the content creator and recipient. As a point of fact, a content creator would use ST1 to establish a communications platform between himself and his content—he would “subscribe himself” to his content. In other words, access to digital content also becomes subscription-based once ST1 has been used to scramble that content.

Because it is inherently a personalized scrambling technology, ST1 provides a subscription-based platform model that facilitates “pay-per-play” transactions in a B2B environment. Therefore, ST1 not only provides security, it also opens up personalized one-to-one marketing communication channels, and thus potential for numerous B2B and B2C applications—each of which is “securely personalized.”

With digital technology erasing any distinction between voice, data, video, and audio, a single set of rules can be applied to all methods of electronic communications—wired, wireless, cable and satellite—even laser and fiber optics. The preferred set of rules is for all such communications to be securely personalized and thereby subscription-based.

It should also be apparent that the key could be maintained and distributed by any suitable secure key management infrastructure, including those implemented by a third party to the sender and the recipient. Moreover, the sender, third party, and/or other entity could charge a fee for providing at least some aspect of the secure key management infrastructure. Any such entities could, for example, limit access to the message using a pay per play subscription model. Indeed, embodiments are contemplated where wherein a sender broadcasts the message in scrambled format to first and second recipients, and at least one of the sender and the third party charge different amounts to the first and second recipients for access to the same message.

In terms of software implementations, it is contemplated that a first portion of the system could be implemented as software on a sending computer, and the sending computer could transmit the multiple parts of the message, via VPN for example, in a scrambled sequence. The sending computer could also embed the message with information that instruct specific tests or processes at the recipient. A second portion of the system could also be implemented as software on a recipient's computer, which software could be used to authenticate the message, using message hash plus key, or other technique.

E. IP-Based Networks

ST1 also takes advantage of Internet Protocol (IP) to help create securely personalized channels for subscription-based communications. IP can be described as the common thread that holds the entire Internet together. It is responsible for moving data from one host to another, using various cost-based techniques (or ‘routing’ algorithms).

IP has revolutionized the Way in which we communicate and conduct business. Blocks of IP addresses are assigned to individuals or organizations and are similar to a postal code used by a post office to route letters to a general area. Personal computers currently use IP addresses for communications. The Internet is arranged around IP addresses and the computers attached to the network know where to send data by the IP address of the device requesting it.

Within the next few years, with the transition from IPv4 to IPv6, the inventor believes everybody will have his or her own personal IP address. Each will be able to send and receive communications and data at any point in time and space with any digital appliance.

F. IP-based Networks and the OEM

To help understand the realm within which embodiments of the invention are expected to work, and the market niche it can help create and dominate, it is helpful to see the future link between IP-based networks, equipment manufacturers, and communications. It is important to realize that electronic equipment is now being manufactured with IP addresses. By way of example, Sony and other content providers are tending towards making their audio/visual products “IP address enabled.” The electronics company believes that in the age of the Internet over which all kinds of content is sent and received through the Internet, both sides should have IP addresses for better communications. This goes hand in hand with another initiative by Sony to develop a home networking technology that will link together all the gadgets found in a home and make it easy to move and manage the multimedia files stored on them. Sony will start selling a wireless tablet that will act as the central remote control for this home network.

Soon every professional and consumer audio-visual device will have an IP address built in. Ultimately every refrigerator and garage door opener will have an IP address. The era of stand-alone products is over. As this manufacturing practice becomes more common, and IP-based equipment becomes ubiquitous, networks of a very different nature can be created. People will be able to send and receive communications and data at any point in time and space and with any digital appliance. People will be able to use the networks to access content, exchange content with other devices and to conduct preventative maintenance and software upgrades.

As that vision is realized, a new era of “two-way personalized broadcast” will become a reality (which is exactly how ‘radio’ was first used). Contemplated embodiments of securely personalized subscription-based models for communications will become vital for setting up and securing such individualized platforms—and opening the door to B2B and B2C transactions over these potential networks. In short, the impact of “IP address enabled” equipment manufacturing practices by companies is expected to provide a way to avoid OEM hardware issues. In this way a significant barrier to entry has been eliminated—no firmware is needed. Although hardware embodiments are contemplated, the entire implementation can be software-based.

G. IP-based Networks, the OEM, and ST1

In a particularly preferred embodiment, a platform can provide a number of subscription-based customer marketing opportunities to OEMs once equipment becomes “IP address enabled.” Because OEM manufacturers will presumably want to create a one-to-one marketing platform with its customers, it is contemplated that they would send their customers to an appropriate portal to subscribe to the security/personalization service. Although such portals and services could be provided by any number of different companies, for purposes of this application it is named S/portal.

In such an embodiment, it is contemplated that all users would first subscribe to S/portal for a fee to access its services, just as someone who wants to subscribe to MacAfee's™ online virus protection service would go to the MacAfee portal and pay for that service. The fee paid to S/portal would facilitate a subscription to the S/portal and permit a download of ST1 software. Being subscribed to the S/portal provides for updates to the user's platform when needed.

Upon subscription, personalization would take place. In order to make the user's platform unique, certain initialization processes would occur. ST1 software does this automatically and transparently through a direct link to the S/portal.

Once this process is complete the user can now set up a completely unique subscription-based communication platform with any other party or parties who also use ST1. That platform could be created between the user and another person, or an organization, or an OEM and its marketing department.

Therefore, OEMs would also subscribe to the S/portal in order to facilitate a one-to-one communication/marketing platform with customers. Also, an OEM could be licensed to provide its own customers with ST1 software by uploading ST1 directly to its customers' appliance, i.e., a DVD player.

In either case, be it directly or indirectly, the S/portal functions as a link between all ST1 users/subscribers. Users of the ST1 kernel access the e S/portal so the initial personalization process can occur. Ongoing changes to the subscriber's personalization process can also be facilitated through the S/portal by the subscribers over time.

H. The “IP Address Ready” Equipment Network Model

Looking to the future, it is expected that the present inventive subject matter will become ever more valuable. One trend that is contemplated to push the world in this direction is IP enablement of music and other devices. Another trend is phasing out of music CDs in favor of DVD or other media that are large enough to store visuals such as the music video, graphics, lyrics, and other rich media.

For example, assume that an end-user has an IP enabled DVD player and a computer, both of which are connected to the Internet. Under those circumstances an OEM provider can perform maintenance, do software upgrades, etc. If the OEM and the end-user agree, ST1 can provide the secure channel for these two parties to begin communications and open the channels for one-to-one marketing. The S/portal would initially provide the software to both. The OEM would then be able to subscribe the end-user to its securely personalized communication platform, and the OEM could use this platform as a marketing tool and a value-add for the end-user.

The model is particularly advantageous from the OEM's standpoint because the OEM could communicate directly with its DVD player or other hardware residing in the end-user's home. Among other things, this could give the OEM access to very detailed marketing information such as who he is, where he is, what his listening habits are, and the various artists the customer likes to listen to, or watch.

Given that communications are two-way, the end-user would also be able to communicate directly with his DVD player, HDTV, or other equipment, as well as with the OEM. In addition, the end-user could give various rewards. For example, if the OEM tracts the end-user as “a heavy media consumer” it could provide a range of value-adds, such as free music or movie DVDs, special advance releases, etc.

The S/portal would therefore provide the OEM and its customers with a unique communication platform for securely personalized sales and marketing purposes—not just a delivery system. Because ST1 can create this uniquely identified one-to-one marketing platform via this communications network between the OEM, its equipment, and the consumer, sales and marketing opportunities can be well targeted. Each consumer would have a separate, private, and secure intranet with the OEM.

Contemplated ST1 embodiments would also work well with end-users who want to create their own DVD or other libraries. For example, an end-user purchases a Sony DVD player, but wants to store and play music from an independent, such as the underground group Xmusic. Simply loading the music or other content on the equipment will not work because the song is scrambled. Ideally, the equipment would then trigger handshaking between the end-user's equipment and the content creator or owner, using ST1. The end-user would wind up paying for the content (the transaction is automatically scrambled by ST1 so it's secure), and the music, videos or other content would be unscrambled and made accessible to the end-user's player.

Thus, in a unique way, the content creator will be able to communicate with the media he has created and scrambled through the ST1 kernel. ST1 therefore paves the way for the subscription-based personalized “pay-per-play” model. Once the independent's content is scrambled with ST1 the end-user will not be able to access it until he subscribes, for, say, a one-time subscription or perhaps a 100-play subscription. After the 100th play, the end-user would have to re-subscribe to pay for additional plays.

I. The ST1 Communication Network

All three participants can now communicate with each other separately: the OEM, marketing, and the content creator each have the capability to communicate with the user: in his home, with the equipment residing there, and even with the media (scrambled with ST1) playing in it. Once convergence occurs, ST1 can be used to securely personalize any resulting network by forming an intranet within the Internet for the users, making a one-to-one marketing platform that is subscription-based only to those users. Therefore ST1 can facilitate an IP-based “pay-per-play” model on a B2B or B2C platform.

Just as the CD-ROM is slowly being phased out by the larger media storage capabilities of DVD, so too will the DVD disappear—thanks to ST1. In the near future the content creator will use his securely personalized ST1 communication channel with the user to market and distribute his content directly into the user's computer. The computer, functioning as a server, will distribute all ST1 scrambled entertainment media to wireless media appliances (that are “IP address ready”) located throughout the household.

J. The Entertainment Industry

ST1 can also be used to implement secure broadcasting. Since the content creator will be able to communicate with the media residing in the DVD player and with the user, the content creator has the capability to communicate with the user in his home, the equipment, and the media. ST1 can personalize that process through a one-to-one marketing platform that is subscription-based and securely personalized (a personalized intranet on top of the Internet.)

Therefore ST1 facilitates an IP-based “pay-per-play” model. A music or video DVD scrambled by ST1 would demand that the user contact the content creator and ask to be subscribed to the creator's communication platform. Only then would the data be unscrambled for viewing by the creator.

K. Digital Rights Management (DRM) and ST1

There is much controversy surrounding potential DRM solutions for piracy prevention. Among the numerous criticisms is that the scheme gives too much power to copyright holders. But there's a deeper problem: Perfect enforcement of rules is by its nature unfair. As David Weinberg states in an article titled “Copy Protection Is A Crime,” society is based on bending the rules.

Digital rights management sounds unobjectionable on paper: Consumers purchase certain rights to use creative works and are prevented from violating those rights. Who could balk at that except the pirates? Fair is fair, right? Well, no. In reality, our legal system usually leaves us wiggle room. What's fair in one case won't be in another—and only human judgment can discern the difference.

Human judgment is exactly what ST1 allows. By implementing ST1, the owner of the content has the choice to either charge a fee or not. This is because a personalized communication channel would be created between the content user and the content creator. Two-way communications would occur. After all, ST1 is meant to personalize the relationship; bring the fan and the creator together, and provide for a marketing and distribution system—as well as privacy. This allows the content owner to impose rules if necessary. Unlike DRM, leeway is the default with ST1 and rules are the exception.

As David Weinberg suggests, . . . the fact that sometimes we resort to rules shouldn't lead us to think that they are the norm. Fairness means knowing when to make exceptions. After all, applying rules equally is easy. Any bureaucrat can do it. It's far harder to know when to bend or even ignore the rules. That requires being sensitive to individual needs, understanding the larger context, balancing competing values, and forgiving transgressions when appropriate.

But in the digital world—the global marketplace of ideas made real—we're on the verge of handing amorphous, context-dependent decisions to hard-coded software incapable of applying the snicker test. This is a problem, and not one that more and better programming can fix. That would just add more rules. What we really need is to recognize that the world—online and off—is necessarily imperfect, and that it's important it stay that way.

Since human judgment is actually possible with ST1, the creator can allow Mary (who has received the creator's content from the end-user) to use the media for free if, say, Mary subscribes to the creator's communications (marketing) platform. The power behind ST1 is that content copying can now be promoted, allowing the consumer to become the distributor, thus generating more connections between potentially new consumers and the content creator—with S/portal in the middle.

Therefore, this simple act of free will on the part of the content creator, which is not possible with DRM solutions, provides the creator with the ability to promote and sell other products in the future, and maintain a relationship with his customer base.

As stated previously, a good scrambling system is one that can effectively make the picture unusable to all except those who have paid. The ST1 scrambling system is a process that can effectively make any digital data—not just video—unusable to all except those who have subscribed to the ST1 platform. Whether or not a fee-based model is applied to allow access to that data (or communication) is dependent on the creator. But now the choice is there. ST1 will also provide the secured content transmissions once it is implemented as a universal protocol. This is based on the impact of ST1 on communications and data. With respect to communication channels, ST1 creates a personalized transmission medium that allows only a select few to reach a computer while restricting others from doing the same. With respect to data transmission and storage, ST1 performs a scrambling process that transforms data into such a personalized format that the information itself becomes proprietary.

Together, these functionalities give ST1 subscribed users the ability to generate extreme personalization, which is used to secure information in a very unique manner. ST1 is a process that securely personalizes communications and digital data of any kind.

Given that ST1 can securely personalize data and the communication channels, it can also secure the payment transaction for purchasing that data. This would apply to any industry, including entertainment.

L. Basic Overview of RGB Channel Splitting (“RGB”)

Channel splitting separates a visual image into its respective parts. RGB makes 3 new images from the original with each representing the Red, Green, and Blue representations of the image. Each representation can then be manipulated and then put back together enhancing only the color representations that you changed.

RGB is an adjunct to ST1 that can be utilized when addressing visual entertainment media, and provides a next-generation patentable upgrade. The upgrade that combines ST1 with RGB is referred to herein as Mime.

As currently embodied, ST1 cannot by itself specifically address the scrambling of visual media because it cannot distinguish between the types of data it is scrambling; the scrambling of audio, video, text and graphics is performed homogenously. Therefore, it cannot target only an image. However, by first applying RGB to the process ST1 can now distinctly target an image for secure scrambling, distribution, and/or storage.

In combination, the functional relationship between ST1 and RGB for the processing of visual media would be as follows:

By combining RGB with ST1 to create Mime, visual media such as still pictures, film (video) and HDTV in the broadcast environment, can be specifically targeted for scrambling, and thereby securely personalize RGB information by scrambling it in this manner. This turns each visual media element into a proprietary format—unique to the content creator—for storage/retrieval or real-time transmission. This also opens the door for locating each of the three RGB digital elements (called “objects”) for storage anywhere in the world. A method we refer to as “distributed object fragmentation” (DOF).

In the following discussion on DOF, shared items (e.g. software programs, songs, movies, books, etc.) are all referred to as objects. The organizations or persons who create objects are called creators, and the computers used to share objects are called hosts.

A centralized server structure is more vulnerable to hack attack, and a dedicated host is a singular target. A distributed server structure, however, provides a manner in which to store the media within a number of hosts as (a) a stealth tactic, and (b) a method to get as close to the “last mile” of the recipient as possible to help increase resolution. ST1 is key to the functionality of this system, for it is needed to not only ensure stealth to maintain security, but to also recognize and retrieve stealth files.

ST1 is a process that securely personalizes digital media of any kind: Personalization of an object occurs by scrambling the object based upon a creator's uniquely predetermined ST1 qualifiers. This process allows the object to become “digitally fingerprinted” and inexorably linked to the creator of the object. The object is rendered secure because its data is uniquely scrambled as well as encrypted. The entire process takes place automatically by passing the object through the ST1 kernel where the object becomes reformatted in a securely personalized configuration.

The ST1 process can securely personalize “static” data (that which is not changed). However, ST1 can also securely personalize “dynamic” data (that which is generated “on-the-fly”). Therefore ST1 can be used statically, for the secure storage of information, or dynamically to secure communications, i.e., real-time data transmissions, as described below:

With respect to communications, the ST1 process can be used in a real-time point-to-point, or point-to-points, transmission where the data is scrambled, transmitted, and then automatically descrambled upon reception in real-time. In this scenario the technology's inherent functionality is similar to time division multiplexing (TDM). Both sender and receiver would utilize the ST1 kernel.

With respect to storage, the ST1 process can produce locally a version of an object that has been scrambled for storage on a host or device whereby only the original creator of the processed object can descramble the stored object. Only the content creator (via his or her personalized ST1 engine) will be able to identify the unique fingerprint of the object, thereby providing the ability to securely co-locate the object within a host.

The advent of ST1 fingerprinting capabilities can provide a mechanism for the easy migration of objects to other hosts for indefinite storage while disguising stored objects so that individual hosts may not know what objects are stored on them.

M. The System: Securely Personalized Distributed Object Fragmentation (SPDOF)

A. Object Fragmentation: First, the digital object is fragmented into it base elements. For an object such as a book, this could mean all the chapters are separated; a movie media object could be fragmented into its Red Green Blue (RGB) elements; a musical object could be divided into a number of frequency ranges.

B. Secure Personalization: If fragmented objects were to be located in a third-party host, the content fragments would be protected and identifiable. Therefore, once a digital object has been broken down into its elemental parts, the ST1 process can securely personalize each object fragment for identification. ST1 fingerprints the object by means of the unique scrambling process generated by the creator's customized communication platform. In this function, unlike the anonymity of distributed object fragments, ST1 simplifies the effort required by the content creator—or law-enforcement agency—to determine the original source of the copyrighted bits.

C. Decentralization: Object Fragmentation facilitates the use of distributed hosts and, as a consequence, anonymity of the object being stored. Decentralization complicates the effort of hackers to determine the original source (and thereby the “value”) of the copyrighted bits. By physically re-distributing the storage of valuable data the content creator's object is physically removed from a single host which thereby (a) eliminates access by unauthorized users (e.g., employees who may have an inkling of the value of the object) thus reducing the chance of internal theft) and (b) separates the elements for storage locally on host servers at other sites—even in other countries—to eliminate the chance of direct external attacks of an in-house host that is known, or suspected to exist, by the hacker.

Inevitably, the objects would be moved from a fragmented state to a continuous state. Once ST1 authenticates the creator—based on his or her uniquely predetermined qualifiers—it will unscramble, recombine, and decrypt the object fragments.

Ordinarily, the entire “master” version of the object could be securely personalized with ST1 without prior object fragmentation. This is still a viable method of securely personalizing an object. However, since ST1 has the ability to easily fingerprint and thus identify fragmented objects and reassemble them based on the content creator's unique communication setup, it provides for the use of Object Fragmentation as an additional means of securing a valuable object via the distributed computing method.

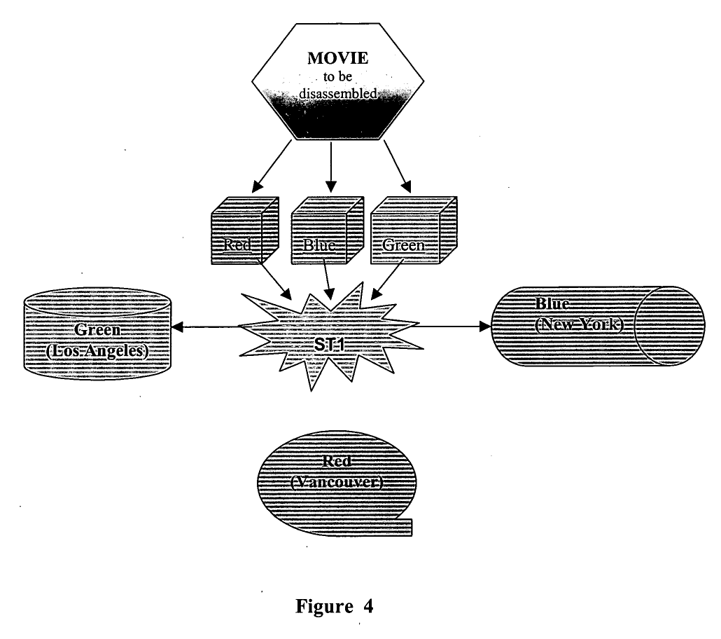

Steps B (Secure Personalization) and C (Decentralization) become the “Disassembly” module of the process (FIG. 4).

CASE 1: Mime Protecting the Film Industry Via SPDOF

A movie media object would be fragmented into its Red Green Blue (RGB) elements via RGB Channel Splitting. Each separate element is then securely personalized through the ST1 engine. The media can now be distributed safely over any open network to three separate hosts. In this case, ST1 functions comparably to STDM and dynamically utilizes encryption algorithms that are randomly assigned to data packets as the packets are scrambled (based on each content creator's personalized ST1 platform). These three hosts can be located anywhere in the world (wherever such server co-location services are provided). All objects would be placed back together sequentially.

CASE 2: Protecting the Music Industry Via SPDOF

A music media object could be put through three frequency-sampling processes, or perhaps one Fast Fourier Transform process where it would be split into three streams for co-location. For example, a 512 pole FFT can take a sampling of frequencies and divide by 512 giving the bandwidth of each pole. You could split 256 into three groups: send 0-64 for a low-pass filter; 65-128 for a band-pass filter; and 129-256 as a high-pass filter. Again, all objects would be placed back together sequentially. Here ST1 functions like Frequency Division Multiplexing (FDM), i.e., “This packet belongs to this frequency using this algorithm at that time.”

CASE 3: Protecting General Content for Enterprises

Although Mime is specific for visual media, various combinations of ST1, Mime, and distributed object fragmentation could be utilized to secure valuable digital information. For example, documents, e-books, etc., could be broken down into a number of different object fragments by the content creator and securely stored in stealth mode anywhere in the world.

N. The Personalized Distribution Platform: ST1 and Subscription-Based Communications

In any of the above cases, whether or not DOF is used, the ST1 process can generate an infinite number of versions of an object scrambled in the content creator's unique format. Content (a song or a movie) can be distributed electronically or stored on media, such as CD-ROM or DVD. A content creator can now utilize free mass-market distribution of the content since access to the object can now only be provided by permission of the content creator—access to the creator's computer, or the creator's media, is always based on the common denominator: subscription-based communications. This becomes the genesis of one-to-one marketing where a personalized channel is created between the content creator and the content user using ST1 as the protocol for the communication platform for all commerce and communications.

Thus, it is contemplated that articles of commerce could be produced, sold and purchased, that implement at least part of a cryptographic system that splits a digital message into multiple parts, and scrambles sequencing of the multiple parts according to an algorithm requiring first and second keys to resolve. Such articles of commerce could, for example, comprise a memory that stores the message according to the scrambled sequencing. Such memories could be re-writable or read-only, volatile or non-volatile, and could comprise a spinning media such as a CD or DVD or later generation of these, and could alternatively comprise a solid state media such as found on a memory stick, or implemented in some of the IPod™ or PDAs.

It is also contemplated that such articles of commerce include a telephone, cell phone, or other telephony device that digitizes a voice as the message, and that transmits the scrambled multiple parts of the message. Such telephony devices can advantageously use an IP (Internet Protocol) technology to carry the scrambled multiple parts of the message.

In still other embodiments, it is contemplated that articles of commerce can include a computer that receives the scrambled multiple parts of the message, uses the second key to de-scramble the message, and stores the message. A particularly preferred embodiment involves a television, computer or other device with a display screen, where the device receives the scrambled multiple parts of the message, uses the second key to de-scramble the message, and displays the message as a moving image on the display screen.

From another perspective, the present application contemplates methods of storing and retrieving data, comprising: utilizing a cryptographic system to split a digital message into multiple parts, which are then stored on different hosts; and using the cryptographic system to resolve locations and sequencing of the multiple parts of the message. Such methods include embodiments where: (a) the different hosts are geographically separated from one another; (b) where a first entity initiates storage of the message on the different hosts, and a second entity different from the first entity utilizes first and second keys to determine resolve the locations and sequencing of the multiple parts of the message; and (c) where the first and second keys are provided by a third party or other secure key management infrastructure. The data can be audio, video, textual, diagrammatic, or any other type of data, and thus contemplated messages include movies, books and music. Moreover, the message can be split according to color separations, video and audio tracts, different frequency ranges, or in any other manner.

Thus, the present application has described embodiments of novel technologies in which data is scrambled using time or otherwise varied encryption techniques. It should be apparent, however, to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps could be present, or utilized, or combined with other elements, components, or steps that are not expressly referenced.

1. A cryptographic system that splits a digital message into multiple parts, and scrambles sequencing of the multiple parts according to an algorithm requiring first and second keys to resolve.

2. The system of claim 1, wherein the message includes digitized video data.

3. The system of claim 1, wherein at least one of the multiple parts is encrypted.

4. The system of claim 1, wherein the first key varies across the multiple parts of the message.

5. The system of claim 1, wherein the first and second keys are related according to a graphically recognizable mathematical formula.

6. The system of claim 5, wherein the formula defines a triangle.

7. The system of claim 1, wherein the first and second keys are provided by a secure key management infrastructure.

8. The system of claim 7, wherein the message is sent from a first party to a second party, and the secure key management infrastructure comprises a third party.

9. The system of claim 8 wherein at least one of a sender of the message and the third party charges a fee for providing at least some aspect of the secure key management infrastructure.

10. The system of claim 8 wherein at least one of a sender of the message and the third party limits access to the message using a pay per play subscription model.

11. The system of claim 8 wherein a sender broadcasts the message in scrambled format to first and second recipients, and at least one of the sender and the third party charge different amounts to the first and second recipients for access to the same message.

12. The system of claim 1, wherein the first key is a public key and the second key is a private keys.

13. The system of claim 1, wherein a first portion of the system is implemented as software on a sending computer, and the sending computer transmits the multiple parts of the message in a scrambled sequence.

14. The system of claim 13, wherein the sending computer embeds the message with information that instruct specific tests or processes at the recipient.

15. The system of claim 13, the sending computer transmits the multiple parts of the message using a virtual private network technology.

16. The system of claim 13, wherein a second portion of the system is implemented as software on a recipient's computer.

17. The system of claim 16, wherein the software on the recipient's computer authenticates the message.
